(19) United States
(12) Patent Application Publication
(10) Pub. No.: US 2025/0309960 A1
(43) Pub. Date: Oct. 2, 2025

(54) CONNECTIONS BETWEEN RESOURCES FOR PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Arumugam CHENDAMARAI KANNAN, San Diego, CA (US); Hamed PEZESHKI, San Diego, CA (US); Tao LUO, San Diego, CA (US)

(21) Appl. No.: 18/863,550

(22) PCT Filed: Jul. 28, 2022
(86) PCT No.: PCT/CN2022/108466

§ 371 Date: Nov. 6, 2024

(51) Int. Cl. H04B 7/06; H04W 24/10; H04W 72/044

(52) U.S. Cl. CPC H04B 7/0626; H04B 7/06968; H04W 24/10; H04W 72/046

(57) ABSTRACT

Various aspects of the present disclosure generally relate to wireless communication. In some aspects, a mobile station may receive, from a network node, an indication of a first set of resources and a second set of resources and an indication of one or more connections between the first set of resources and the second set of resources. The mobile station may transmit, to the network node, a channel state information report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station. Numerous other aspects are described.

### FIELD OF THE DISCLOSURE

Aspects of the present disclosure generally relate to wireless communication and to techniques and apparatuses for connections between resources for predictive beam management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a mobile station for wireless communication. The mobile station may include a memory and one or more processors coupled to the memory. The one or more processors, based at least in part on information stored in the memory, may be configured to receive, from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The one or more processors may be configured to transmit, to the network node, a channel state information (CSI) report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections.

Some aspects described herein relate to a network node for wireless communication. The network node may include a memory and one or more processors coupled to the memory. The one or more processors, based at least in part on information stored in the memory, may be configured to transmit an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The one or more processors may be configured to receive a CSI report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.

Some aspects described herein relate to a method of wireless communication performed by a mobile station. The method may include receiving, by the mobile station and from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The method may include transmitting, by the mobile station and to the network node, a CSI report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections.

Some aspects described herein relate to a method of wireless communication performed by a network node. The method may include transmitting, by the network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The method may include receiving, by the network node, a CSI report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.

Some aspects described herein relate to a non-transitory computer-readable medium that stores a set of instructions for wireless communication by a mobile station. The set of instructions, when executed by one or more processors of the mobile station, may cause the mobile station to receive, from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The set of instructions, when executed by one or more processors of the mobile station, may cause the mobile station to transmit, to the network node, a CSI report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections.

Some aspects described herein relate to a non-transitory computer-readable medium that stores a set of instructions for wireless communication by a network node. The set of instructions, when executed by one or more processors of the network node, may cause the network node to transmit an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The set of instructions, when executed by one or more processors of the network node, may cause the network node to receive a CSI report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.

Some aspects described herein relate to an apparatus for wireless communication. The apparatus may include means for receiving, from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The apparatus may include means for transmitting, to the network node, a CSI report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections.

Some aspects described herein relate to an apparatus for wireless communication. The apparatus may include means for transmitting an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The apparatus may include means for receiving a CSI report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture of a functional framework for radio access network (RAN) intelligence enabled by data collection, in accordance with the present disclosure.

FIG. 6 is a diagram illustrating an example of an artificial intelligence/machine learning (AI/ML) based beam management, in accordance with the present disclosure.

FIGS. 7A-7D are diagrams illustrating an example associated with connections between resources for predictive beam management, in accordance with the present disclosure.

FIG. 8 is a diagram illustrating an example process performed, for example, by a mobile station, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

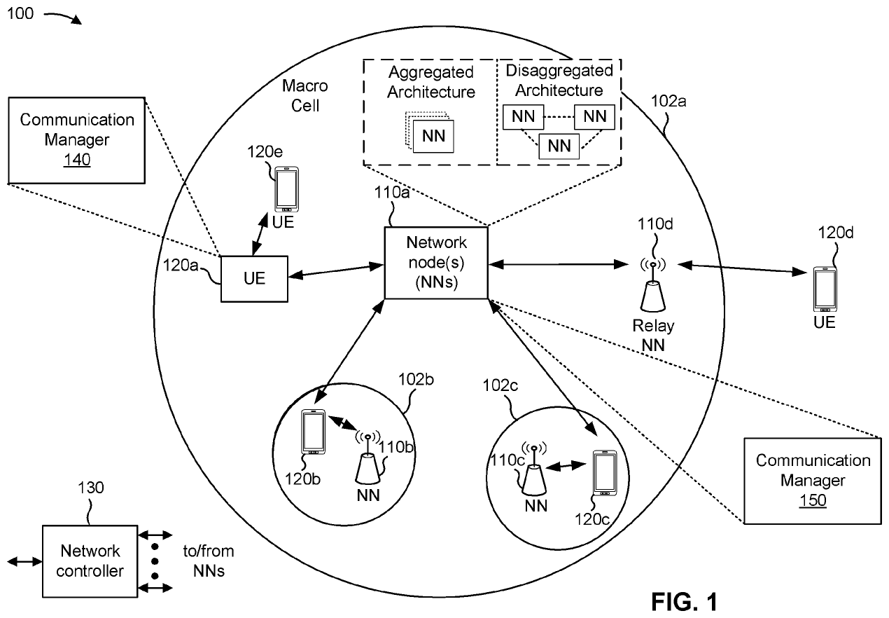

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and transmit, to the network node, a channel state information (CSI) report indicating measurement values associated with the first set of resources and the second set of resources, wherein a first one or more measurement values, from the measurement values, associated with the first set of resources are measured by the UE 120, and wherein a second one or more measurement values, from the measurement values, associated with the second set of resources are predicted by the UE 120 based at least in part on the first one or more measurement values and the one or more connections. Additionally, or alternatively, the communication manager 140 may perform one or more other operations described herein.

In some aspects, the network node 110 may include a communication manager 150. As described in more detail elsewhere herein, the communication manager 150 may transmit an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and receive a CSI report associated with a UE indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections. Additionally, or alternatively, the communication manager 150 may perform one or more other operations described herein.

As indicated above, FIG. 1 is provided as an example. Other examples may differ from what is described with regard to FIG. 1.

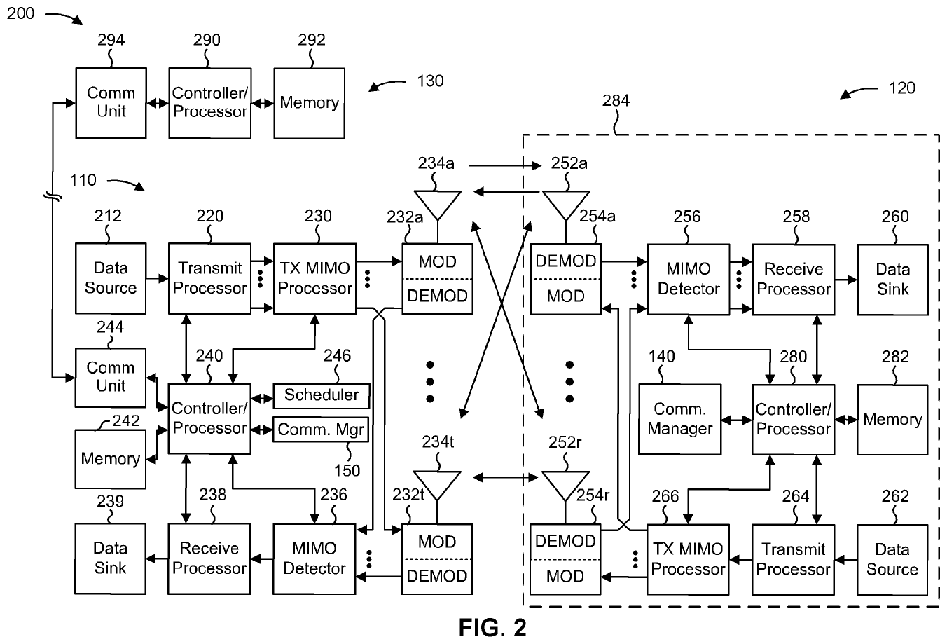

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

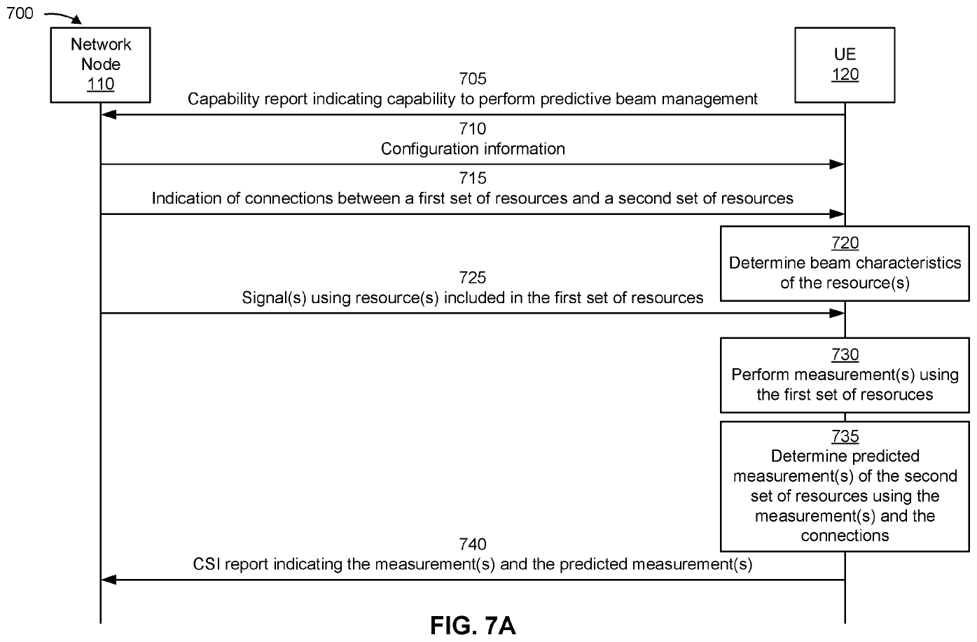

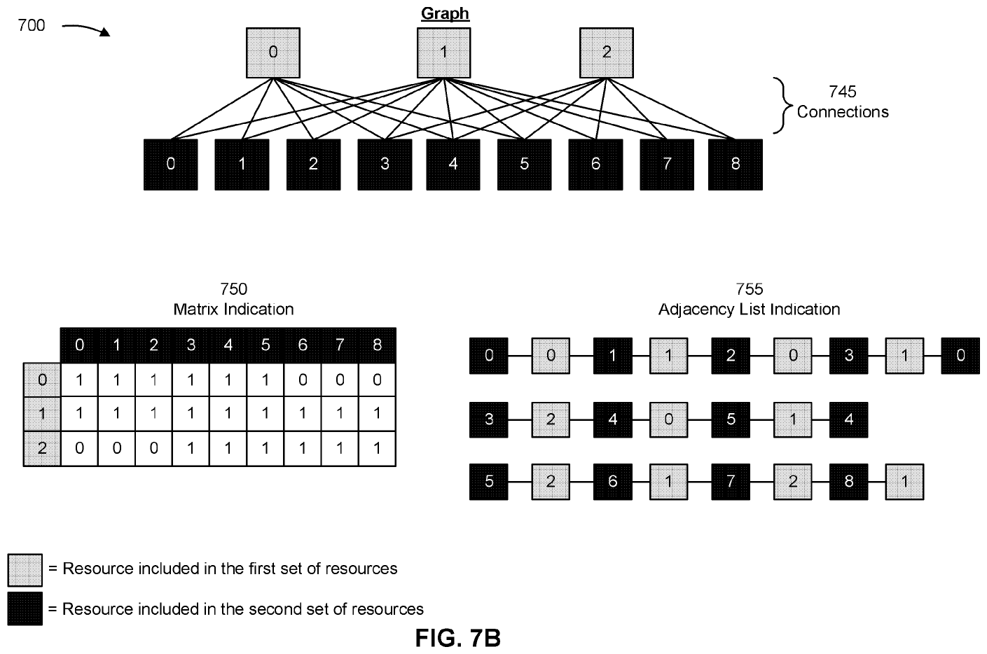

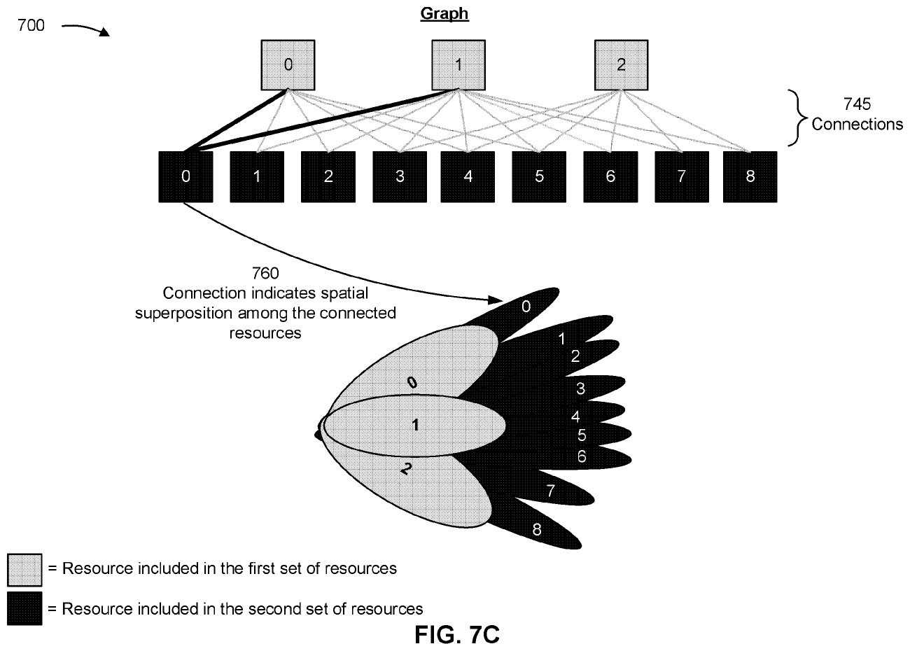

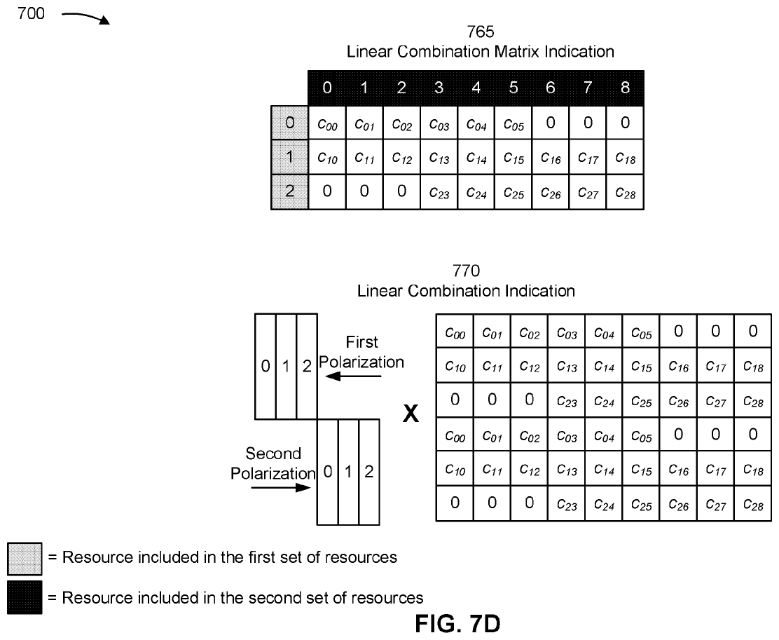

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-7D and 8-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-7D and 8-11).

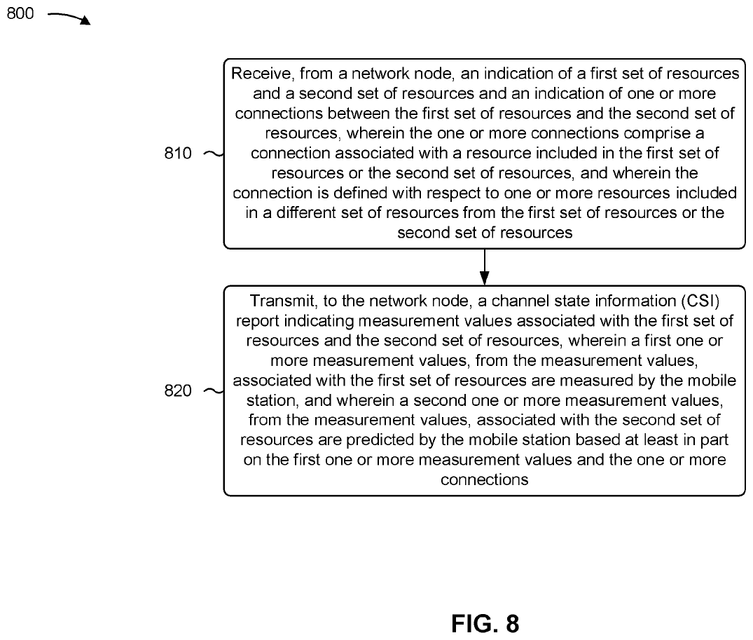

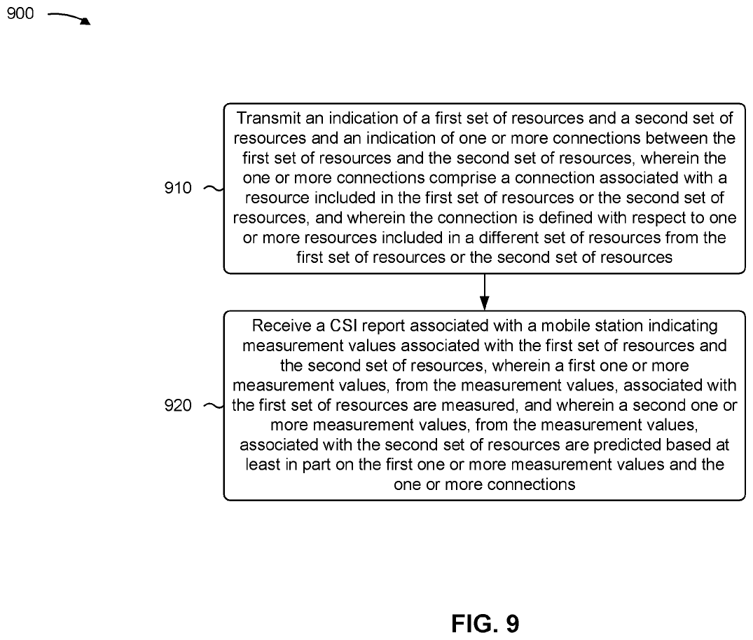

The controller/processor 240 of the network node 110, the controller/processor 280 of the UE 120, and/or any other component(s) of FIG. 2 may perform one or more techniques associated with connections between resources for predictive beam management, as described in more detail elsewhere herein. In some aspects, the mobile station described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and/or means for transmitting, to the network node, a CSI report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and/or means for receiving a CSI report associated with a UE indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

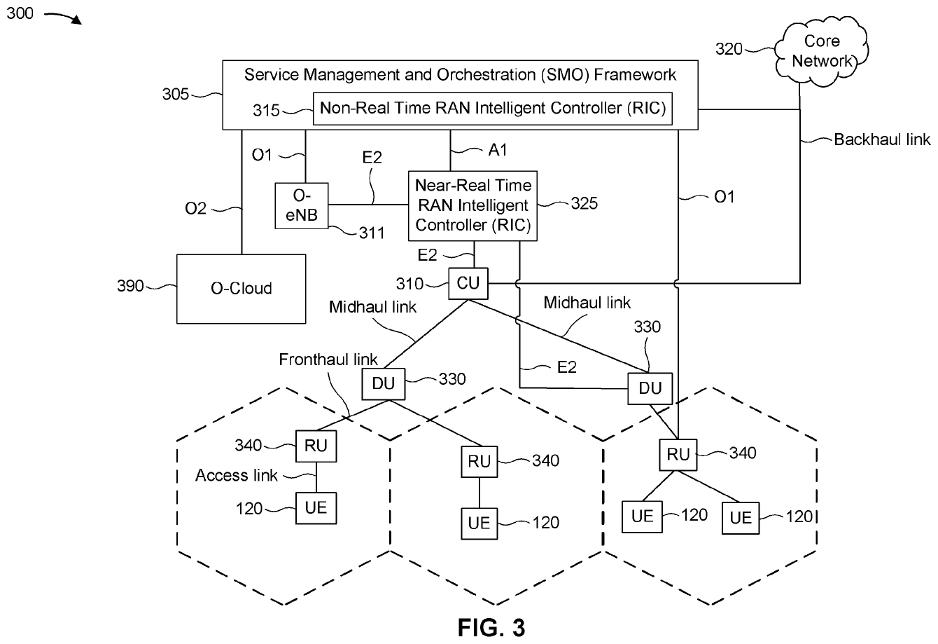

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325. In some examples, the near-RT RIC 325 may be a logical function that enables near-real-time control and optimization of O-RAN elements and resources via fine-grained data collection and actions over an E2 interface. The Near-RT RIC 325 may be collocated with the RAN or network entity to provide the real-time processing, such as online ML training or near real time ML inference. The non-RT RIC 315 may be a logical function that enables non-real-time control and optimization of RAN elements and resources, AI/ML workflow including model training and updates, and policy-based guidance of applications/features in near-RT RIC 325, as well as ML inference with less latency specification. The non-RT RIC 315 may be located further from the RAN or network node, such as on a cloud-based server or on an edge server.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

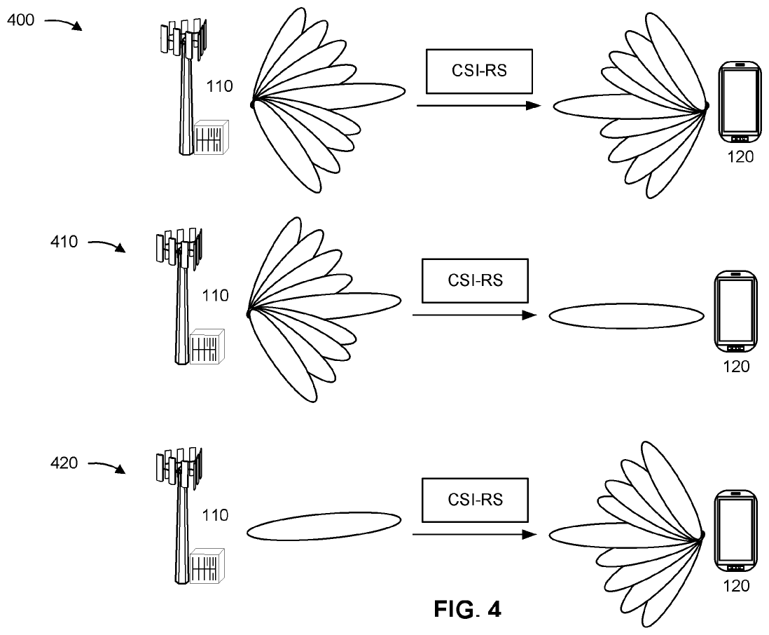

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHz, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 4) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

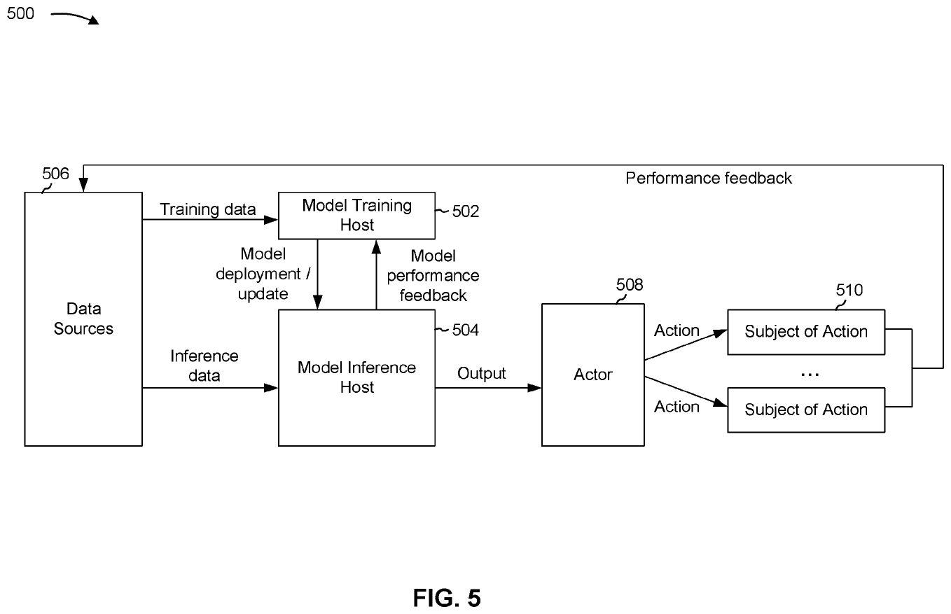

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU; whereas if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a Tx/Rx beam based on the output. If the actor 508 determines to act based on the output, the actor 508 may indicate the action to at least one subject of action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify its Tx/Rx beam based on the beam (re-)configuration, such as switching to a new Tx/Rx beam or applying different parameters for a Tx/Rx beam, among other examples. As another example, the actor 508 may be a UE and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

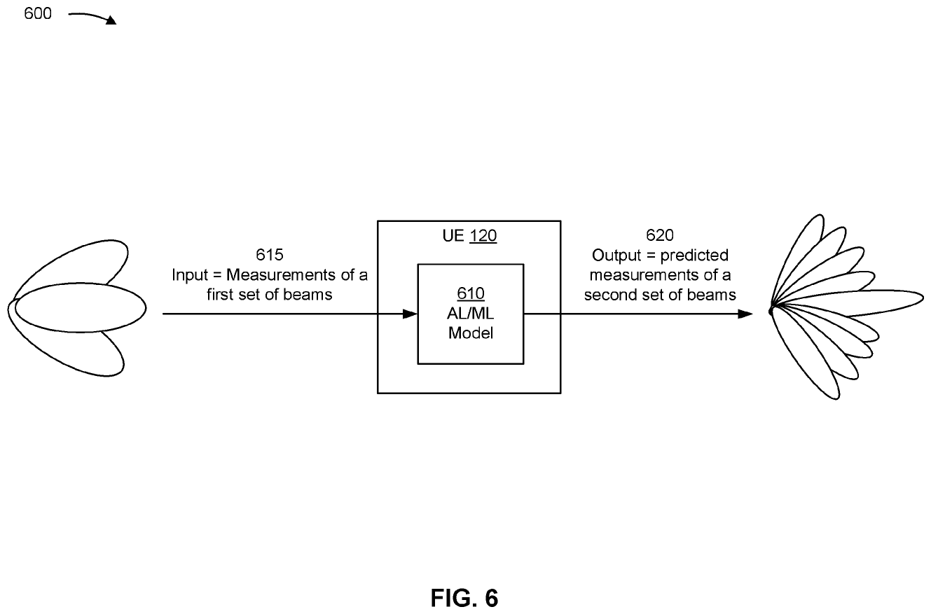

FIG. 6 is a diagram illustrating an example 600 of an AI/ML based beam management, in accordance with the present disclosure. As shown in FIG. 6, an AL/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. For example, a network node 110 may transmit one or more signals values respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the A/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/MIL model 610 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 610. This may enable the AI/ML model 610 to output codebook based and/or non-codebook based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

As described above, to perform the predictions described herein, the UE 120 and/or the AI/ML model 610 may require information associated with the first set of beams and/or the second set of beams in order to accurately perform the predictions. For example, the UE 120 and/or the AI/ML model 610 may use information such as a beam direction (e.g., spatial direction), beam width, beam shape, and/or other characteristics of the respective beams from the first set of beams and/or the second set of beams to accurately perform the predictions described above. However, this information may be associated with beamforming techniques performed at a network node 110. Therefore, the network node 110 may transmit, and the UE 120 may receive the information (e.g., a beam direction (e.g., spatial direction), beam width, beam shape, and/or other characteristics of the respective beams from the first set of beams and/or the second set of beams). However, this may consume significant signaling overhead, especially in cases where the network node 110 may dynamically change beamforming techniques or shapes (e.g., thereby requiring another transmission of the information described above). Further, explicit indications of the beamforming techniques performed at a network node 110 may require detailed disclosures of proprietary or confidential information. Therefore, in some cases, a network node 110 may not provide explicit indications of some, or all, of the information needed by the UE 120 to accurately perform the predictions described above. As a result, AI/ML predictions performed by the UE 120 may be degraded because the UE 120 may not have access to information of beam characteristics or shapes of beams associated with the AI/ML predictions.

Some techniques and apparatuses described herein are associated with connections between resources for predictive beam management. For example, the UE 120 may receive an indication of a first set of resources and a second set of resources and an indication of one or more connections between the first set of resources and the second set of resources. The one or more connections may include a connection associated with a resource, included in the first set of resources or the second set of resources, that is defined with respect to one or more resources included in a different set of resources from the first set of resources or the second set of resources. In other words, the connections may be implicit connections defining beam characteristics associated with a given resource with respect to beams associated with other resources(s) that are included in a different set. In some examples, the connection described herein may be referred to as an implicit connection, an association, a relation, a relationship, a correspondence, a mapping, and/or a link, among other examples. The connection may indicate a relationship between a first spatial direction or a first beam associated with the resource and second spatial directions or second beams of the one or more resources included in the different set of resources. The first set of resources may be channel measurement resources for a CSI report and the second set of resources may be resources that are not to be actually measured by the UE 120 (e.g., nominal resources). For example, the first set of resources may be associated with Set B beams and the second set of resources may be associated with Set A beams. In some aspects, the connections may be graph-based connections or may be linear combinations.

The UE 120 may transmit a CSI report indicating measurement values associated with the first set of resources and the second set of resources. A first one or more measurement values, from the measurement values, associated with the first set of resources may be measured by the UE 120. A second one or more measurement values, from the measurement values, associated with the second set of resources may be predicted by the UE 120 based at least in part on the first one or more measurement values and the one or more connections. In other words, the UE 120 may use the connections between the first set of resources and the second set of resources to obtain beam characteristics or beam shapes associated with the first set of resources and the second set of resources. The UE 120 may use the beam characteristics or beam shapes associated with the first set of resources and the second set of resources to perform one or more AI/ML predictions associated with the first set of resources and the second set of resources.

In some aspects, one or more resources included in the second set of resources may be used for a transmission configuration indicator (TCI) state indication. Additionally, or alternatively, one or more resources included in the second set of resources may be used by the UE 120 as a source reference for a quasi co-location (QCL) source (e.g., even though the UE 120 has not actually received and/or measured signal(s) via the second set of resources).

As a result, the UE 120 may be enabled to perform improved predictive beam management by obtaining beam characteristics (e.g., beam shape and/or beam width) associated with the first set of resources and the second set of resources. Additionally, by using implicit connections between two sets of resources, the UE 120 and/or a network node 110 may conserve a signaling overhead, network resources, processing resources, and/or power associated with indicating the beam characteristics (e.g., beam shape and/or beam width) associated with the first set of resources and the second set of resources. For example, by using implicit connections between the two sets of resources, detailed beamforming information or implementations performed at a network node 110 do not need to be disclosed or indicated to the UE 120.

As indicated above, FIG. 6 is provided as an example. Other examples may differ from what is described with regard to FIG. 6.

FIGS. 7A-7D are diagrams illustrating an example 700 associated with connections between resources for predictive beam management, in accordance with the present disclosure. As shown in FIG. 7A, a network node 110 (e.g., a base station, a CU, a DU, and/or an RU) may communicate with a UE 120. In some aspects, the network node 110 and the UE 120 may be part of a wireless network (e.g., the wireless network 100). The UE 120 and the network node 110 may have established a wireless connection prior to operations shown in FIG. 7A.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 7A, and by reference number 705, the UE 120 may transmit, and the network node 110 may receive, a capability report. The capability report may indicate that the UE 120 supports performing predictive beam management, as described herein. For example, the capability report may indicate that the UE 120 supports performing one or more operations as described in connection with FIGS. 5 and 6. In some aspects, the capability report may indicate that the UE 120 supports identifying beam information for performing predictive beam management using connections between two sets of resources, as described in more detail elsewhere herein. In some aspects, the UE 120 may be configured to perform one or more operations described herein based at least in part on the capability report indicating that the UE 120 supports performing predictive beam management.

As shown by reference number 710, the network node 110 may transmit, and the UE 120 may receive, configuration information. In some aspects, the UE 120 may receive the configuration information via one or more of system information signaling, RRC signaling, one or more MAC-CEs, and/or DCI, among other examples. In some aspects, the configuration information may include an indication of one or more configuration parameters (e.g., already stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to perform predictive beam management. For example, the configuration information may indicate that the UE 120 is to use an AI/ML model and/or a model inference host deployed at, or associated with, the UE 120 to predict measurement values (e.g., L1 RSRP values) associated with one or more beams. For example, the configuration information may indicate that the UE 120 is to predict measurement values associated with transmit beam(s) of the network node 110 (e.g., of an RU) using measurement value(s) (e.g., performed by the UE 120) of other transmit beam(s) of the network node 110.

In some aspects, the configuration information may indicate a first set of resources and a second set of resources. In some aspects, the first set of resources may include downlink reference signal resources, such as SSB resources or CSI-RS resources, among other examples. In some aspects, the first set of resources may be channel measurement resources (CMRs) for CSI reporting (e.g., may be indicated via a resourcesForChannelMeasurement information element). In some aspects, the second set of resources may include nominal resources. As used herein, “nominal resource” may refer to a resource (e.g., a time-frequency resource or a radio resource) that is indicated or configured for the UE 120, but is not used for transmission (or is infrequently used for transmission) by the network node 110. For example, the second set of resources may include one or more downlink reference signal resources (e.g., SSB resources or CSI-RS resources) that are infrequently used, or not used, for transmissions by the network node 110. In some other examples, the second set of resources may include one or more virtual resources or logical resources (e.g., resources that are not used for transmission by the network node 110).

In some aspects, a given resource (e.g., from the first set of resources and/or the second set of resources) may be associated with a beam. For example, the network node 110 may associated a given resource with a given beam. In the case where the resource is used for transmission by the network node 110, the network node 110 may transmit using the resource and the beam. In some aspects, the first set of resources may be associated with Set B beams of the network node 110 and the second set of resources may be associated with Set A beams of the network node 110. In some aspects, the first set of resources may be a subset of the second set of resources. In some other aspects, the first set of resources may include different resources (e.g., may be mutually exclusive sets).

In some aspects, the configuration information may include a CSI configuration. For example, the configuration information may include a CSI report setting and/or a CSI resource setting, among other examples. As another example, the configuration information may include a CSI-ReportConfig configuration and/or a CSI-ResourceConfig configuration, among other examples. In other words, the configuration information may configure the UE 120 to transmit a CSI report including information (e.g., measurements) associated with the first set of resources and the second set of resources. As described above, the first set of resources may be CMRs for the CSI report.

In some aspects, the configuration information may indicate a report quantity configuration for the CSI report. For example, the UE 120 may be configured with a CSI-ReportConfg with the higher layer parameter reportQuantity set to either ‘none’, ‘cri-RI-PMI-CQI’, ‘cri-RI-i1’, ‘cri-RI-i1-CQI’, ‘cri-RI-CQI’, ‘cri-RSRP’, ‘ssb-Index-RSRP’ or ‘cri-RI-LI-PMI-CQ’, among other examples (for example, as defined, or otherwise fixed, by the 3GPP). The report quantity may indicate or configure what is to be included in the CSI report, what the UE 120 is to expect to be configured with for the CSI report, among other examples. In other words, the report quantity may indicate what kind of quantity (e.g., SSB RSRP, CQI, precoding matrix indicator (PMI), and/or rank indicator (RI)) should be measured and reported by the UE 120. For example, a wireless communication standard, such as the 3GPP, may define expectations and/or configurations for the CSI report for different values of the report quantity. In some aspects, a report quantity associated with the CSI report to be transmitted by the UE 120 may be based at least in part on the second set of resources (e.g., the nominal resources). For example, the second set of resources may be used to define the report quantity of the CSI configuration. In some aspects, the second set of resources may be used as references of report quantities in CSI reporting (e.g., The first set of resources may be used as CMRs for a CSI report, while the report quantities for the CSI report may be defined based at least in part on the second set of resources). For example, the UE 120 may receive a configuration (e.g., a CSI report setting, a CSI resource setting, a CSI-ReportConfig, and/or a CSI-ResourceConfig) for the CSI report. The configuration may indicate that the first set of resources are channel measurement resources associated with the CSI report and that the second set of resources are references associated with a report quantity associated with the CSI report.

The UE 120 may configure itself based at least in part on the configuration information. In some aspects, the UE 120 may be configured to perform one or more operations described herein based at least in part on the configuration information.

As shown by reference number 715, the network node 110 may transmit, and the UE 120 may receive, an indication of one or more connections between the first set of resources and the second set of resources. For example, the one or more connections may be implicit connections. In some aspects, the indication of one or more connections may be included in the configuration information (e.g., the configuration information and the indication of the one or more connections may be included in the same communication or configuration). In some other aspects, the indication of one or more connections may be transmitted to the UE 120 separate from the configuration information.

For example, a connection associated with a resource, included in the first set of resources or the second set of resources, that is defined with respect to one or more resources included in a different set of resources from the first set of resources or the second set of resources. In some aspects, the connection may indicate a relationship between a first spatial direction or a first beam associated with the resource and second spatial directions or second beams of the one or more resources included in the different set of resources. In other words, the connections may implicitly indicate beams and/or spatial directions associated with a given resource by connecting the given resource to one or more other resources included in a different set of resources.

As shown in FIG. 7B, in some examples, the one or more connections may include a graph-based connection. For example, the graph-based connection may be based at least in part on a graph, such as the graph depicted in FIG. 7B. For example, the graph associated with the graph-based connection may include nodes for respective resources included in the first set of resources and the second set of resources. As shown by reference number 745, the one or more connections may include, or be indicated by, one or more edges. As an example, a first edge, from the one or more edges, may indicate a connection between a first node associated with the first set of resources and a second node associated with the second set of resources. Edges may connect two nodes associated with resources included in different sets. Each node associated with a resource included in the first set of resources may be connected with multiple edges associated with different nodes that are associated with different resources included in the second set of resources. Similarly, each node associated with a resource included in the second set of resources may be connected with multiple edges associated with different nodes that are associated with different resources included in the first set of resources.

For example, as shown in FIG. 7B, the connections may indicate that a node associated with a resource 0 from the second set of resources is associated with a first edge associated with a resource 0 from the first set of resources and a second edge associated with a resource 1 from the first set of resources. This may indicate that the resource 0 from the second set of resources is connected with the resource 0 and the resource 1 from the first set of resources. As another example, a resource 3 from the second set of resources may be associated with a first edge associated with the resource 0 from the first set of resources, a second edge associated with the resource 1 from the first set of resources, and a third edge associated with a resource 2 from the first set of resources. This may indicate that the resource 3 from the second set of resources is connected with the resource 0, the resource 1, and the resource 2 from the first set of resources.

In some aspects, the network node 110 may indicate the graph-based connection via a matrix. As an example, the network node 110 may indicate the matrix to the UE 120 via one or more bitmaps. For example, as shown by reference number 750, a matrix may indicate the edges associated with the graph. For example, in some cases, an entry in the matrix associated with a value of “1” may indicate that a connection, or an edge, exists between resources associated with the entry. An entry in the matrix associated with a value of “0” may indicate that a connection, or an edge, does not exist between resources associated with the entry.

In some aspects, each edge, of the one or more edges, may indicate a probability level or a strength level of a spatial connection between two nodes associated with different sets of resources from the first set of resources and the second set of resources. For example, rather than elements or entries of the matrix indicating binary values of “1” or “0” (e.g., that indicate a presence or absence of an edge or a connection), the elements or entries of the matrix may indicate probability levels or strength levels that indicate how probable or how strong respective connections between nodes (or resources) are (e.g., may indicate a connection probability or a connection strength). For example, a probability level or a strength level may be a value between 0 and 1. A value closer to a value of 0 may indicate that a connection between two resources is weak or less probable, whereas a probability level or a strength level closer to a value of 1 may indicate that a connection between two resources is strong or more probable.

For example, the UE 120 may receive an indication of an adjacency matrix (e.g., as shown by reference number 750) indicating the graph associated with the graph-based connection. The one or more connections may be indicated by respective elements of the adjacency matrix. As described above, the respective elements of the adjacency matrix may indicate probability levels or a strength levels associated with the one or more connections (e.g., rather than values of “1” or “0” as shown in FIG. 7B).

As another example and as shown by reference number 755, the network node 110 may use an adjacency list to indicate the connections between the first set of resources and the second set of resources. An adjacency list may be a collection of unordered lists used to represent a finite graph. Each unordered list within an adjacency list describes the set of neighbors of the graph. For example, as shown in FIG. 7B, the adjacency list may include three lists. The UE 120 may receive an indication of the adjacency list indicating the graph and/or the connections between the first set of resources and the second set of resources. The one or more connections may be indicated by respective neighboring nodes in the adjacency list. For example, if two nodes are connected in an adjacency list, this may indicate that the two nodes are connected in the graph (e.g., and that adjacency associated with the nodes are connected). In some aspects, a link between neighboring nodes in the adjacency list may indicate probability levels or a strength levels associated with the one or more connections, in a similar manner as described above.

As shown in FIG. 7C, a connection indicated by the graph may indicate a spatial superposition relationship between a first spatial direction or a first beam associated with a resource and second spatial directions or second beams associated with the one or more resources included in the different set of resources (e.g., that are indicated as being connected with the resource by the graph). In other words, the graph-based implicit connection between the first set of resources and the second set of resources may indicate spatial superpositions among connected resources. For example, a connection may indicate that a first beam width of the first beam associated with the resource may be overlapping with second beam widths of the second beams. In other words, if the graph indicates that a first resource (e.g., included in the second set of resources) is connected with a second resource (e.g., included in the first set of resources), then the UE 120 may assume the beam width associated with the first resource is within the beam width associated with the second resource.

In some aspects, a beam width may include an angular spread that is associated with an attenuation difference from a peak beamforming gain, of a beam associated with the beam width, that satisfies a threshold (e.g., X decibels (dB) of attenuation). In other words, beam width may be defined as angular spread that is within X dB attenuation with respect to the peak beamforming gain of the beam. In some aspects, a value of the threshold (e.g., X) may be defined, or otherwise fixed, by a wireless communication standard, such as the 3GPP. Additionally, or alternatively, a value of the threshold (e.g., X) may be included in the indication of the one or more connections between the first set of resources and the second set of resources. In some aspects, the threshold may include a first threshold (e.g., X₁) associated with the first set of resources and a second threshold (e.g., X₂) associated with the second set of resources.

As an example and as shown in FIG. 7C, the graph may indicate that the resource 0 included in the second set of resources is connected to the resource 0 and the resource 1 included in the first set of resources. As shown by reference number 760, the connections may indicate spatial superpositions among the connected resources. For example, as shown in FIG. 7C, the connections may indicate that a beam width of a beam associated with the resource 0 included in the second set of resources in included within a beam width of a beam associated with the resource 0 included in the first set of resources and within a beam width of a beam associated with the resource 1 included in the first set of resources. From this information, the UE 120 may be enabled to extrapolate and/or perform predictions for the beam associated with the resource 0 in the first set of resources based at least in part on measurements of the resource 0 and the resource 1 that are included in the first set of resources, as described in more detail elsewhere herein.

As another example, and as shown in FIG. 7D, the one or more connections may include linear combination based connections. For example, the connections may indicate that a beam of a resource included in the second set of resources is a linear combination of one or more beams associated with respective resources included in the first set of resources (e.g., the connection may be associated with a linear combination of the one or more resources). Alternatively, the connections may indicate that a beam of a resource included in the first set of resources is a linear combination of one or more beams associated with respective resources included in the second set of resources.

As an example, a linear combination may be associated with one or more linear combination coefficients that are associated with respective resources from the one or more resources. For example, the linear combination coefficients may be beamforming coefficients. In some aspects, the linear combination coefficients may be amplitude and phase coefficients.

In some aspects, as shown by reference number 765, the UE 120 may receive an indication of a matrix indicating the linear combination based connections, where linear combination coefficients are indicated by respective elements of the matrix. For example, the network node 110 may indicate linear combination coefficients associated with respective connections between resources included in the first set of resources and the second set of resources. As another example, the UE 120 may receive an indication of an adjacency list indicating the linear combination based connections (e.g., in a similar manner as described in connection with FIG. 7B). For example, linear combination coefficients may be indicated by respective neighboring nodes in the adjacency list.

As shown by reference number 770, the UE 120 may receive an indication of a codebook-based matrix associated with the first set of resources and the second set of resources and a polarization matrix. The linear combination coefficients may be indicated by respective elements of the codebook matrix. For example, the linear combination coefficients may be indicated via a matrix that has a similar format as a codebook matrix (e.g., a wideband Type-II CSI feedback codebook as defined, or otherwise fixed, by a wireless communication standard, such as the 3GPP). For example, rather than the codebook matrix being associated with spatial domain bases and/or layers, the codebook matrix may be associated with resources from the first set of resources and the second set of resources. By using a matrix having this format, the polarization domain may also be taken into consideration when indicating the linear combinations.

Returning to FIG. 7A, the connections between resources in the first set of resources and the second set of resources may be configured for a given CSI report (e.g., may be configured dedicated for CSI reports). For example, the connections may be specific to a given CSI report configuration.

For example, for periodic or semi-persistent CSI reports, the connections may be indicated in a configuration for the CSI reports. For example, the UE 120 may receive a CSI report setting associated with the CSI report. The CSI report setting may include the indication of the one or more connections between the first set of resources and the second set of resources. As another example, the UE 120 may receive a CSI resource setting associated with the CSI report. The CSI resource setting may include the indication of the one or more connections between the first set of resources and the second set of resources. For example, the CSI resource setting may include an indication of the first set of resources, the second set of resources, and the connections between the first set of resources the second set of resources (e.g., may indicate the graph and/or the linear combinations as described in more detail elsewhere herein).

For a semi-persistent CSI report, the UE 120 may receive a MAC-CE communication activating a transmission of the CSI report. In some aspects, the MAC-CE communication may include the indication of the one or more connections between the first set of resources and the second set of resources. As another example, for an aperiodic CSI report, the UE 120 may receive DCI triggering a triggering state associated with the CSI report. In some aspects, the triggering state may include the indication of the one or more connections between the first set of resources and the second set of resources. For example, the UE 120 may receive configurations (e.g., RRC configurations) for one or more triggering states that indicate respective connections between the first set of resources and the second set of resources. The UE 120 may receive DCI that triggers a given trigger state. The UE 120 may identify the connections between the first set of resources and the second set of resources based at least in part on a configuration of the given triggering state.

In some aspects, the connections may be configured irrespective of a CSI report configuration or setting. For example, the UE 120 may receive, and the network node 110 may transmit, an RRC configuration including information associated with respective resources from the first set of resources and the second set of resources. In some aspects, the RRC configuration may include the indication of the one or more connections between the first set of resources and the second set of resources. For example, the connections may be RRC configured by each respective information element of the first set of resources (e.g., an SSB information element or a CSI-RS information element) and/or the second set of resources.

As shown by reference number 720, the UE 120 may determine beam characteristics of, or spatial associations between, resources included in the first set of resources and the second set of resources. For example, the UE 120 may use the graph-based connection(s) to identify two or more resources that are associated with a spatial superposition of respective beams of the two or more resources (e.g., as depicted and described in more detail in connection with FIG. 7C). As another example, the UE 120 may determine linear combinations among resources included in the first set of resources and the second set of resources. In other words, the UE 120 may use the connections to obtain spatial information and/or beam information associated with resources included in the first set of resources and the second set of resources. The UE 120 may use this information to perform one or more predictions associated with beam management, as described elsewhere herein. For example, the UE 120 may provide this information and/or an indication of the connections as an input to an AI/ML model used for predictive beam management.

As shown by reference number 725, the network node 110 may transmit, and the UE 120 may receive, one or more signals using resources included in the first set of resources. For example, the network node 110 may transmit, and the UE 120 may receive, one or more SSBs or CSI-RSs using resources included in the first set of resources. As shown by reference number 730, the UE 120 may perform measurements of the signals that are associated with the first set of resources. For example, the UE 120 may perform L1 RSRP measurements of the signals that are associated with the first set of resources.

As shown by reference number 735, the UE 120 may determine one or more predicted measurements of the second set of resources using the measurements (e.g., performed as described above in connection with reference number 730) and the connections (e.g., indicated to the UE 120 as described above in connection with reference number 715 and/or FIGS. 7B-7D). For example, the UE 120 may input the measurements performed by the UE 120 and indication(s) of the connections (or beam/spatial information determined by the UE 120 based at least in part on the connection) to an AI/ML model. The AI/ML model may output predicted measurement values associated with the second set of resources, as described in more detail elsewhere herein.

As shown by reference number 740, the UE 120 may transmit, and the network node 110 may receive, a CSI report indicating measurement values associated with the first set of resources and the second set of resources. A first one or more measurement values, from the measurement values, associated with the first set of resources may be measured by the UE 120 (e.g., as described above in connection with reference number 730). A second one or more measurement values, from the measurement values, associated with the second set of resources may be predicted by the UE 120 based at least in part on the first one or more measurement values and the one or more connections (e.g., as described above in connection with reference number 735). In this way, the UE 120 may be enabled to perform predictive beam management without requiring detailed beamforming or spatial information associated with the network node 110 (e.g., associated with beamforming performed by the network node 110). This may reduce a signaling overhead associated with enabling the UE 120 to perform the predictive beam management.

In some aspects, based at least in part on performing the predictive beam management, a resource, included in the second set of resources, may be used as a QCL source resource for a TCI state. For example, the QCL source resource may be a QCL Type-D QCL (e.g., as defined, or otherwise fixed, by a wireless communication standard, such as the 3GPP). For example, a QCL Type-D may be associated with a shared spatial receive parameter between the source and target reference signals.

In some aspects, the UE 120 may receive, and the network node 110 may transmit, an indication of a TCI state that is associated with a QCL source reference that is associated with at least one resource from the second set of resources. For example, based at least in part on performing the predictive beam management, the TCI state may be a known TCI state (e.g., based at least in part on a measurement value associated with the at least one resource being included in the second one or more measurement values included in the CSI report).

For example, a beam may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. A spatial relation may indicate a directionality or a characteristic of the uplink beam, similar to one or more QCL properties, as described above.

In some aspects, the UE 120 and/or the network node 110 may perform TCI state switching. TCI state switching may involve known TCI states and unknown TCI states. A TCI state switching timeline may specify the delay between receiving a reference signal (RS) resource (e.g., CSI-RS, SSB) used for L1 RSRP measurement reporting for the target TCI state (activated TCI state) and completion of an active TCI state switch. The RS resource is the RS in the activated TCI state or QCL'ed to the activated TCI state.

The TCI state switching timeline for the TCI state switching period may depend on whether an activated TCI state is known or unknown. A TCI state is known if multiple conditions are met. The multiple conditions may include: (condition #1) if the TCI state switch command is received within 1280 milliseconds (ms) upon the last transmission of the RS resource for beam reporting or measurement; (condition #2) if the UE has transmitted at least 1 L1 RSRP report for the target TCI state before the TCI state switch command; (condition #3) if the TCI state remains detectable during the TCI state switching period (e.g., from the slot carrying the TCI state activation MAC-CE to TCI switching completion); and (condition #4) if the SSB associated with the TCI state remains detectable during the TCI switching period. An RS may be detectable by the UE if the signal-to-noise ratio (SNR) for the RS is greater than or equal to 3 decibels (dB). This does not necessarily mean that there must be such an RS being transmitted. This might be verified by the UE via other RSs (e.g., DMRS). If these conditions are not met, the TCI state is unknown. As described above, rather than relying on the multiple conditions, the UE 120 may consider a TCI state to be known if: (1) the UE 120 has been configured/activated/triggered with a CSI report, where the report quantitates of the CSI report are configured/indicated based at least in part on the second set of resources; and (2) the UE 120 having reported at least one predicted L1 RSRP value associated with the resource included in the second set of resources that is associated with the TCI state (e.g., as described above in connection with reference number 740). This may reduce an overhead associated with configuring TCI states and/or may enable the UE 120 to consider additional TCI states to be known by performing the predictive beam management.

As a result, the UE 120 may be enabled to perform improved predictive beam management by obtaining beam characteristics (e.g., beam shape and/or beam width) associated with the first set of resources and the second set of resources. Additionally, by using implicit connections between two sets of resources, the UE 120 and/or a network node 110 may conserve a signaling overhead, network resources, processing resources, and/or power associated with indicating the beam characteristics (e.g., beam shape and/or beam width) associated with the first set of resources and the second set of resources. For example, by using implicit connections between the two sets of resources, detailed beamforming information or implementations performed at a network node 110 do not need to be disclosed or indicated to the UE 120.

As indicated above, FIGS. 7A-7D are provided as examples. Other examples may differ from what is described with respect to FIGS. 7A-7D.

FIG. 8 is a diagram illustrating an example process 800 performed, for example, by a mobile station, in accordance with the present disclosure. Example process 800 is an example where the mobile station (e.g., the UE 120) performs operations associated with connections between resources for predictive beam management.

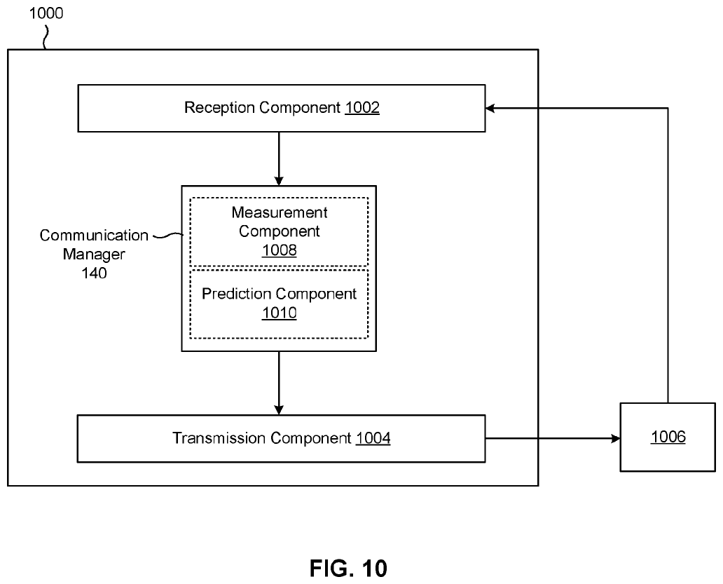

As shown in FIG. 8, in some aspects, process 800 may include receiving, from a network node, an indication of a first set of resources and a second set of resources and an indication of one or more connections between the first set of resources and the second set of resources, wherein the one or more connections include a connection associated with a resource included in the first set of resources or the second set of resources, and wherein the connection is defined with respect to one or more resources included in a different set of resources from the first set of resources or the second set of resources (block 810). For example, the mobile station (e.g., using communication manager 140 and/or reception component 1002, depicted in FIG. 10) may receive, from a network node, an indication of a first set of resources and a second set of resources and an indication of one or more connections between the first set of resources and the second set of resources, wherein the one or more connections include a connection associated with a resource included in the first set of resources or the second set of resources, and wherein the connection is defined with respect to one or more resources included in a different set of resources from the first set of resources or the second set of resources, as described above.

As further shown in FIG. 8, in some aspects, process 800 may include transmitting, to the network node, a CSI report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections (block 820). For example, the mobile station (e.g., using communication manager 140 and/or transmission component 1004, depicted in FIG. 10) may transmit, to the network node, a CSI report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections, as described above.

Process 800 may include additional aspects, such as any single aspect or any combination of aspects described below and/or in connection with one or more other processes described elsewhere herein.

In a first aspect, the connection indicates a relationship between a first spatial direction or a first beam associated with the resource and second spatial directions or second beams of the one or more resources included in the different set of resources.

In a second aspect, alone or in combination with the first aspect, the first set of resources are channel measurement resources for the CSI report, and a report quantity associated with the CSI report is based at least in part on the second set of resources.

In a third aspect, alone or in combination with one or more of the first and second aspects, the first set of resources include one or more downlink reference signal resources.

In a fourth aspect, alone or in combination with one or more of the first through third aspects, the second set of resources include one or more downlink reference signal resources.

In a fifth aspect, alone or in combination with one or more of the first through fourth aspects, the second set of resources include one or more virtual resources.

In a sixth aspect, alone or in combination with one or more of the first through fifth aspects, a resource, included in the second set of resources, is a QCL source resource for a TCI state.

In a seventh aspect, alone or in combination with one or more of the first through sixth aspects, the QCL source resource is a Type D QCL source resource.

In an eighth aspect, alone or in combination with one or more of the first through seventh aspects, the one or more connections include a graph-based connection.

In a ninth aspect, alone or in combination with one or more of the first through eighth aspects, a graph associated with the graph-based connection includes nodes for respective resources included in the first set of resources and the second set of resources, and one or more edges, wherein a first edge, from the one or more edges, indicates a connection between a first node associated with the first set of resources and a second node associated with the second set of resources.

In a tenth aspect, alone or in combination with one or more of the first through ninth aspects, the second node is further associated with a second edge indicating a connection between the second node and a third node that is associated with the first set of resources.

In an eleventh aspect, alone or in combination with one or more of the first through tenth aspects, each edge, of the one or more edges, indicates a probability level or a strength level of a spatial connection between two nodes associated with different sets of resources from the first set of resources and the second set of resources.

In a twelfth aspect, alone or in combination with one or more of the first through eleventh aspects, receiving the indication of the one or more connections between the first set of resources and the second set of resources includes receiving an indication of an adjacency matrix indicating a graph associated with the graph-based connection, wherein the one or more connections are indicated by respective elements of the adjacency matrix.

In a thirteenth aspect, alone or in combination with one or more of the first through twelfth aspects, the respective elements of the adjacency matrix indicate probability levels or a strength levels associated with the one or more connections.

In a fourteenth aspect, alone or in combination with one or more of the first through thirteenth aspects, receiving the indication of the one or more connections between the first set of resources and the second set of resources includes receiving an indication of an adjacency list indicating a graph associated with the graph-based connection, wherein the one or more connections are indicated by respective neighboring nodes in the adjacency list.

In a fifteenth aspect, alone or in combination with one or more of the first through fourteenth aspects, the respective neighboring nodes indicate probability levels or a strength levels associated with the one or more connections.

In a sixteenth aspect, alone or in combination with one or more of the first through fifteenth aspects, the connection indicates a spatial superposition relationship between a first spatial direction or a first beam associated with the resource and second spatial directions or second beams associated with the one or more resources included in the different set of resources.

In a seventeenth aspect, alone or in combination with one or more of the first through sixteenth aspects, the connection indicates that a first beam width of the first beam associated with the resource is overlapping with second beam widths of the second beams.

In an eighteenth aspect, alone or in combination with one or more of the first through seventeenth aspects, a beam width, from the first beam width or the second beam widths, includes an angular spread that is associated with an attenuation difference from a peak beamforming gain, of a beam associated with the beam width, that satisfies a threshold.

In a nineteenth aspect, alone or in combination with one or more of the first through eighteenth aspects, a value of the threshold is included in the indication of the one or more connections between the first set of resources and the second set of resources.

In a twentieth aspect, alone or in combination with one or more of the first through nineteenth aspects, the threshold includes a first threshold associated with the first set of resources and a second threshold associated with the second set of resources.

In a twenty-first aspect, alone or in combination with one or more of the first through twentieth aspects, the one or more connections include linear combination based connections.

In a twenty-second aspect, alone or in combination with one or more of the first through twenty-first aspects, the resource is included in the second set of resources and the one or more resources are included in the first set of resources, and the linear combination based connections indicate that the connection is associated with a linear combination of the one or more resources.

In a twenty-third aspect, alone or in combination with one or more of the first through twenty-second aspects, the linear combination is associated with linear combination coefficients associated with respective resources from the one or more resources.

In a twenty-fourth aspect, alone or in combination with one or more of the first through twenty-third aspects, the linear combination coefficients are amplitude and phase coefficients.

In a twenty-fifth aspect, alone or in combination with one or more of the first through twenty-fourth aspects, receiving the indication of the one or more connections between the first set of resources and the second set of resources includes receiving an indication of a matrix indicating the linear combination based connections, wherein linear combination coefficients are indicated by respective elements of the matrix.

In a twenty-sixth aspect, alone or in combination with one or more of the first through twenty-fifth aspects, receiving the indication of the one or more connections between the first set of resources and the second set of resources includes receiving an indication of a codebook matrix associated with the first set of resources and the second set of resources and a polarization matrix, wherein linear combination coefficients are indicated by respective elements of the codebook matrix.

In a twenty-seventh aspect, alone or in combination with one or more of the first through twenty-sixth aspects, receiving the indication of the one or more connections between the first set of resources and the second set of resources includes receiving an indication of an adjacency list indicating the linear combination based connections, wherein linear combination coefficients are indicated by respective neighboring nodes in the adjacency list.

In a twenty-eighth aspect, alone or in combination with one or more of the first through twenty-seventh aspects, the resource is included in the first set of resources and the one or more resources are included in the second set of resources, and the linear combination based connections indicate that the connection is associated with a linear combination of the one or more resources.

In a twenty-ninth aspect, alone or in combination with one or more of the first through twenty-eighth aspects, receiving the indication of the one or more connections between the first set of resources and the second set of resources includes receiving a configuration for the CSI report, wherein the configuration includes the indication of the one or more connections between the first set of resources and the second set of resources.

In a thirtieth aspect, alone or in combination with one or more of the first through twenty-ninth aspects, the configuration for the CSI report indicates that the first set of resources are channel measurement resources associated with the CSI report and that the second set of resources are references associated with a report quantity associated with the CSI report.

In a thirty-first aspect, alone or in combination with one or more of the first through thirtieth aspects, receiving the indication of the one or more connections between the first set of resources and the second set of resources includes receiving a CSI report setting associated with the CSI report, wherein the CSI report setting includes the indication of the one or more connections between the first set of resources and the second set of resources.

In a thirty-second aspect, alone or in combination with one or more of the first through thirty-first aspects, receiving the indication of the one or more connections between the first set of resources and the second set of resources includes receiving a CSI resource setting associated with the CSI report, wherein the CSI resource setting includes the indication of the one or more connections between the first set of resources and the second set of resources.

In a thirty-third aspect, alone or in combination with one or more of the first through thirty-second aspects, receiving the indication of the one or more connections between the first set of resources and the second set of resources includes receiving a MAC-CE communication activating a transmission of the CSI report, wherein the MAC-CE communication includes the indication of the one or more connections between the first set of resources and the second set of resources.

In a thirty-fourth aspect, alone or in combination with one or more of the first through thirty-third aspects, receiving the indication of the one or more connections between the first set of resources and the second set of resources includes receiving downlink control information triggering a triggering state associated with the CSI report, wherein the triggering state includes the indication of the one or more connections between the first set of resources and the second set of resources.

In a thirty-fifth aspect, alone or in combination with one or more of the first through thirty-fourth aspects, process 800 includes receiving an indication of a TCI state that is associated with a QCL source reference that is associated with at least one resource from the second set of resources.

In a thirty-sixth aspect, alone or in combination with one or more of the first through thirty-fifth aspects, the TCI state is a known TCI state based at least in part on a measurement value associated with the at least one resource being included in the second one or more measurement values included in the CSI report.

In a thirty-seventh aspect, alone or in combination with one or more of the first through thirty-sixth aspects, receiving the indication of the one or more connections between the first set of resources and the second set of resources includes receiving an RRC configuration including information associated with respective resources from the first set of resources and the second set of resources, wherein the RRC configuration includes the indication of the one or more connections between the first set of resources and the second set of resources.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., the network node 110) performs operations associated with connections between resources for predictive beam management.

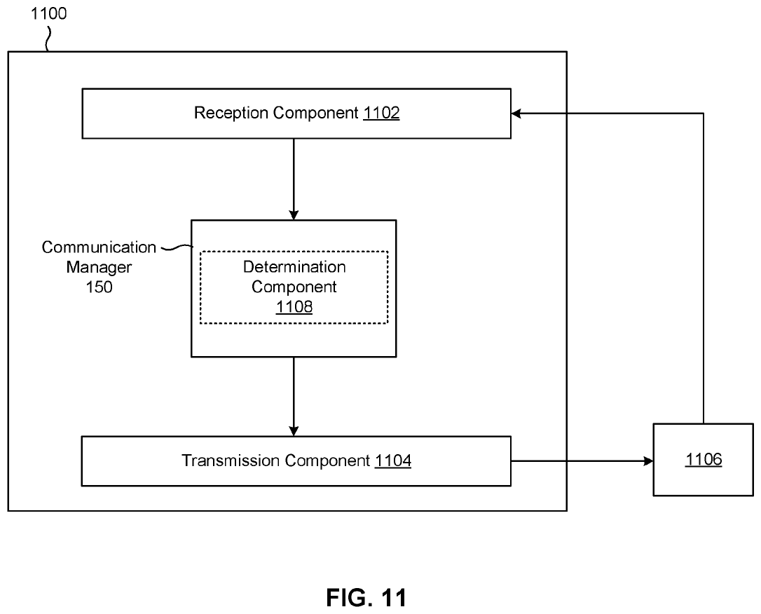

As shown in FIG. 9, in some aspects, process 900 may include transmitting an indication of a first set of resources and a second set of resources and an indication of one or more connections between the first set of resources and the second set of resources, wherein the one or more connections includes a connection associated with a resource included in the first set of resources or the second set of resources, and wherein the connection is defined with respect to one or more resources included in a different set of resources from the first set of resources or the second set of resources (block 910). For example, the network node (e.g., using communication manager 150 and/or transmission component 1104, depicted in FIG. 11) may transmit an indication of a first set of resources and a second set of resources and an indication of one or more connections between the first set of resources and the second set of resources, wherein the one or more connections includes a connection associated with a resource included in the first set of resources or the second set of resources, and wherein the connection is defined with respect to one or more resources included in a different set of resources from the first set of resources or the second set of resources, as described above.

As further shown in FIG. 9, in some aspects, process 900 may include receiving a CSI report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections (block 920). For example, the network node (e.g., using communication manager 150 and/or reception component 1102, depicted in FIG. 11) may receive a CSI report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections, as described above.

Process 900 may include additional aspects, such as any single aspect or any combination of aspects described below and/or in connection with one or more other processes described elsewhere herein.

In a first aspect, the connection indicates a relationship between a first spatial direction or a first beam associated with the resource and second spatial directions or second beams of the one or more resources included in the different set of resources.

In a second aspect, alone or in combination with the first aspect, the first set of resources are channel measurement resources for the CSI report, and a report quantity associated with the CSI report is based at least in part on the second set of resources.

In a third aspect, alone or in combination with one or more of the first and second aspects, the first set of resources include one or more downlink reference signal resources.

In a fourth aspect, alone or in combination with one or more of the first through third aspects, the second set of resources include one or more downlink reference signal resources.

In a fifth aspect, alone or in combination with one or more of the first through fourth aspects, the second set of resources include one or more virtual resources.

In a sixth aspect, alone or in combination with one or more of the first through fifth aspects, a resource, included in the second set of resources, is a QCL source resource for a TCI state.

In a seventh aspect, alone or in combination with one or more of the first through sixth aspects, the QCL source resource is a Type D QCL source resource.

In an eighth aspect, alone or in combination with one or more of the first through seventh aspects, the one or more connections include a graph-based connection.

In a ninth aspect, alone or in combination with one or more of the first through eighth aspects, a graph associated with the graph-based connection includes nodes for respective resources included in the first set of resources and the second set of resources, and one or more edges, wherein a first edge, from the one or more edges, indicates a connection between a first node associated with the first set of resources and a second node associated with the second set of resources.

In a tenth aspect, alone or in combination with one or more of the first through ninth aspects, the second node is further associated with a second edge indicating a connection between the second node and a third node that is associated with the first set of resources.

In an eleventh aspect, alone or in combination with one or more of the first through tenth aspects, each edge, of the one or more edges, indicates a probability level or a strength level of a spatial connection between two nodes associated with different sets of resources from the first set of resources and the second set of resources.

In a twelfth aspect, alone or in combination with one or more of the first through eleventh aspects, transmitting the indication of the one or more connections between the first set of resources and the second set of resources includes transmitting an indication of an adjacency matrix indicating a graph associated with the graph-based connection, wherein the one or more connections are indicated by respective elements of the adjacency matrix.

In a thirteenth aspect, alone or in combination with one or more of the first through twelfth aspects, the respective elements of the adjacency matrix indicate probability levels or a strength levels associated with the one or more connections.

In a fourteenth aspect, alone or in combination with one or more of the first through thirteenth aspects, transmitting the indication of the one or more connections between the first set of resources and the second set of resources includes transmitting an indication of an adjacency list indicating a graph associated with the graph-based connection, wherein the one or more connections are indicated by respective neighboring nodes in the adjacency list.

In a fifteenth aspect, alone or in combination with one or more of the first through fourteenth aspects, the respective neighboring nodes indicate probability levels or a strength levels associated with the one or more connections.

In a sixteenth aspect, alone or in combination with one or more of the first through fifteenth aspects, the connection indicates a spatial superposition relationship between a first spatial direction or a first beam associated with the resource and second spatial directions or second beams associated with the one or more resources included in the different set of resources.

In a seventeenth aspect, alone or in combination with one or more of the first through sixteenth aspects, the connection indicates that a first beam width of the first beam associated with the resource is overlapping with second beam widths of the second beams.

In an eighteenth aspect, alone or in combination with one or more of the first through seventeenth aspects, a beam width, from the first beam width or the second beam widths, includes an angular spread that is associated with an attenuation difference from a peak beamforming gain, of a beam associated with the beam width, that satisfies a threshold.

In a nineteenth aspect, alone or in combination with one or more of the first through eighteenth aspects, a value of the threshold is included in the indication of the one or more connections between the first set of resources and the second set of resources.

In a twentieth aspect, alone or in combination with one or more of the first through nineteenth aspects, the threshold includes a first threshold associated with the first set of resources and a second threshold associated with the second set of resources.

In a twenty-first aspect, alone or in combination with one or more of the first through twentieth aspects, the one or more connections include linear combination based connections.

In a twenty-second aspect, alone or in combination with one or more of the first through twenty-first aspects, the resource is included in the second set of resources and the one or more resources are included in the first set of resources, and the linear combination based connections indicate that the connection is associated with a linear combination of the one or more resources.

In a twenty-third aspect, alone or in combination with one or more of the first through twenty-second aspects, the linear combination is associated with linear combination coefficients associated with respective resources from the one or more resources.

In a twenty-fourth aspect, alone or in combination with one or more of the first through twenty-third aspects, the linear combination coefficients are amplitude and phase coefficients.

In a twenty-fifth aspect, alone or in combination with one or more of the first through twenty-fourth aspects, transmitting the indication of the one or more connections between the first set of resources and the second set of resources includes transmitting an indication of a matrix indicating the linear combination based connections, wherein linear combination coefficients are indicated by respective elements of the matrix.

In a twenty-sixth aspect, alone or in combination with one or more of the first through twenty-fifth aspects, transmitting the indication of the one or more connections between the first set of resources and the second set of resources includes transmitting an indication of a codebook matrix associated with the first set of resources and the second set of resources and a polarization matrix, wherein linear combination coefficients are indicated by respective elements of the codebook matrix.

In a twenty-seventh aspect, alone or in combination with one or more of the first through twenty-sixth aspects, transmitting the indication of the one or more connections between the first set of resources and the second set of resources includes transmitting an indication of an adjacency list indicating the linear combination based connections, wherein linear combination coefficients are indicated by respective neighboring nodes in the adjacency list.

In a twenty-eighth aspect, alone or in combination with one or more of the first through twenty-seventh aspects, the resource is included in the first set of resources and the one or more resources are included in the second set of resources, and the linear combination based connections indicate that the connection is associated with a linear combination of the one or more resources.

In a twenty-ninth aspect, alone or in combination with one or more of the first through twenty-eighth aspects, transmitting the indication of the one or more connections between the first set of resources and the second set of resources includes transmitting a configuration for the CSI report, wherein the configuration includes the indication of the one or more connections between the first set of resources and the second set of resources.

In a thirtieth aspect, alone or in combination with one or more of the first through twenty-ninth aspects, the configuration for the CSI report indicates that the first set of resources are channel measurement resources associated with the CSI report and that the second set of resources are references associated with a report quantity associated with the CSI report.

In a thirty-first aspect, alone or in combination with one or more of the first through thirtieth aspects, transmitting the indication of the one or more connections between the first set of resources and the second set of resources includes transmitting a CSI report setting associated with the CSI report, wherein the CSI report setting includes the indication of the one or more connections between the first set of resources and the second set of resources.

In a thirty-second aspect, alone or in combination with one or more of the first through thirty-first aspects, transmitting the indication of the one or more connections between the first set of resources and the second set of resources includes transmitting a CSI resource setting associated with the CSI report, wherein the CSI resource setting includes the indication of the one or more connections between the first set of resources and the second set of resources.

In a thirty-third aspect, alone or in combination with one or more of the first through thirty-second aspects, transmitting the indication of the one or more connections between the first set of resources and the second set of resources includes transmitting a MAC-CE communication activating a transmission of the CSI report, wherein the MAC-CE communication includes the indication of the one or more connections between the first set of resources and the second set of resources.

In a thirty-fourth aspect, alone or in combination with one or more of the first through thirty-third aspects, transmitting the indication of the one or more connections between the first set of resources and the second set of resources includes transmitting downlink control information triggering a triggering state associated with the CSI report, wherein the triggering state includes the indication of the one or more connections between the first set of resources and the second set of resources.

In a thirty-fifth aspect, alone or in combination with one or more of the first through thirty-fourth aspects, process 900 includes transmitting an indication of a TCI state that is associated with a QCL source reference that is associated with at least one resource from the second set of resources.

In a thirty-sixth aspect, alone or in combination with one or more of the first through thirty-fifth aspects, the TCI state is a known TCI state based at least in part on a measurement value associated with the at least one resource being included in the second one or more measurement values included in the CSI report.

In a thirty-seventh aspect, alone or in combination with one or more of the first through thirty-sixth aspects, transmitting the indication of the one or more connections between the first set of resources and the second set of resources includes transmitting an RRC configuration including information associated with respective resources from the first set of resources and the second set of resources, wherein the RRC configuration includes the indication of the one or more connections between the first set of resources and the second set of resources.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a measurement component 1008, and/or a prediction component 1010, among other examples.

In some aspects, the apparatus 1000 may be configured to perform one or more operations described herein in connection with FIGS. 7A-7D. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The transmission component 1004 may transmit, to the network node, a CSI report indicating measurement values associated with the first set of resources and the second set of resources, wherein a first one or more measurement values, from the measurement values, associated with the first set of resources are measured by the apparatus 1000, and wherein a second one or more measurement values, from the measurement values, associated with the second set of resources are predicted by the apparatus 1000 based at least in part on the first one or more measurement values and the one or more connections.

The measurement component 1008 may measure the first set of resources to obtain the first one or more measurement values. The prediction component 1010 may determine the second one or more measurement values based at least in part on the first one or more measurement values and the one or more connections.

The reception component 1002 may receive an indication of a TCI state that is associated with a QCL source reference that is associated with at least one resource from the second set of resources.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIGS. 7A-7D. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources. The reception component 1102 may receive a CSI report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.

The transmission component 1104 may transmit an indication of a TCI state that is associated with a QCL source reference that is associated with at least one resource from the second set of resources.

The determination component 1108 may determine the one or more connections based at least in part on beamforming used to transmit communications to the mobile station.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a mobile station, comprising: receiving, by the mobile station and from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and transmitting, by the mobile station and to the network node, a channel state information (CSI) report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections.

Aspect 2: The method of Aspect 1, wherein the connection indicates a relationship between a first spatial direction or a first beam associated with the resource and second spatial directions or second beams of the one or more resources included in the different set of resources.

Aspect 3: The method of any of Aspects 1-2, wherein the first set of resources are channel measurement resources for the CSI report, and wherein a report quantity associated with the CSI report is based at least in part on the second set of resources.

Aspect 4: The method of any of Aspects 1-3, wherein the first set of resources comprise one or more downlink reference signal resources.

Aspect 5: The method of any of Aspects 1-4, wherein the second set of resources comprise one or more downlink reference signal resources.

Aspect 6: The method of any of Aspects 1-5, wherein the second set of resources comprise one or more virtual resources.

Aspect 7: The method of any of Aspects 1-6, wherein a resource, included in the second set of resources, is a quasi co-location (QCL) source resource for a transmission configuration indicator (TCI) state.

Aspect 8: The method of Aspect 7, wherein the QCL source resource is a Type D QCL source resource.

Aspect 9: The method of any of Aspects 1-8, wherein the one or more connections comprise a graph-based connection.

Aspect 10: The method of Aspect 9, wherein a graph associated with the graph-based connection comprises nodes for respective resources included in the first set of resources and the second set of resources, and one or more edges, wherein a first edge, from the one or more edges, indicates a connection between a first node associated with the first set of resources and a second node associated with the second set of resources.

Aspect 11: The method of Aspect 10, wherein the second node is further associated with a second edge indicating a connection between the second node and a third node that is associated with the first set of resources.

Aspect 12: The method of any of Aspects 10-11, wherein each edge, of the one or more edges, indicates a probability level or a strength level of a spatial connection between two nodes associated with different sets of resources from the first set of resources and the second set of resources.

Aspect 13: The method of any of Aspects 9-12, wherein receiving the indication of the one or more connections between the first set of resources and the second set of resources comprises: receiving an indication of an adjacency matrix indicating a graph associated with the graph-based connection, wherein the one or more connections are indicated by respective elements of the adjacency matrix.

Aspect 14: The method of Aspect 13, wherein the respective elements of the adjacency matrix indicate probability levels or a strength levels associated with the one or more connections.

Aspect 15: The method of any of Aspects 9-14, wherein receiving the indication of the one or more connections between the first set of resources and the second set of resources comprises: receiving an indication of an adjacency list indicating a graph associated with the graph-based connection, wherein the one or more connections are indicated by respective neighboring nodes in the adjacency list.

Aspect 16: The method of Aspect 15, wherein the respective neighboring nodes indicate probability levels or a strength levels associated with the one or more connections.

Aspect 17: The method of any of Aspects 1-16, wherein the connection indicates a spatial superposition relationship between a first spatial direction or a first beam associated with the resource and second spatial directions or second beams associated with the one or more resources included in the different set of resources.

Aspect 18: The method of Aspect 17, wherein the connection indicates that a first beam width of the first beam associated with the resource is overlapping with second beam widths of the second beams.

Aspect 19: The method of Aspect 18, wherein a beam width, from the first beam width or the second beam widths, comprises an angular spread that is associated with an attenuation difference from a peak beamforming gain, of a beam associated with the beam width, that satisfies a threshold.

Aspect 20: The method of Aspect 19, wherein a value of the threshold is included in the indication of the one or more connections between the first set of resources and the second set of resources.

Aspect 21: The method of any of Aspects 19-20, wherein the threshold comprises a first threshold associated with the first set of resources and a second threshold associated with the second set of resources.

Aspect 22: The method of any of Aspects 1-8, wherein the one or more connections comprise linear combination based connections.

Aspect 23: The method of Aspect 22, wherein the resource is included in the second set of resources and the one or more resources are included in the first set of resources, and wherein the linear combination based connections indicate that the connection is associated with a linear combination of the one or more resources.

Aspect 24: The method of Aspect 23, wherein the linear combination is associated with linear combination coefficients associated with respective resources from the one or more resources.

Aspect 25: The method of Aspect 24, wherein the linear combination coefficients are amplitude and phase coefficients.

Aspect 26: The method of any of Aspects 22-25, wherein receiving the indication of the one or more connections between the first set of resources and the second set of resources comprises: receiving an indication of a matrix indicating the linear combination based connections, wherein linear combination coefficients are indicated by respective elements of the matrix.

Aspect 27: The method of any of Aspects 22-26, wherein receiving the indication of the one or more connections between the first set of resources and the second set of resources comprises: receiving an indication of a codebook matrix associated with the first set of resources and the second set of resources and a polarization matrix, wherein linear combination coefficients are indicated by respective elements of the codebook matrix.

Aspect 28: The method of any of Aspects 22-27, wherein receiving the indication of the one or more connections between the first set of resources and the second set of resources comprises: receiving an indication of an adjacency list indicating the linear combination based connections, wherein linear combination coefficients are indicated by respective neighboring nodes in the adjacency list.

Aspect 29: The method of any of Aspects 22-28, wherein the resource is included in the first set of resources and the one or more resources are included in the second set of resources, and wherein the linear combination based connections indicate that the connection is associated with a linear combination of the one or more resources.

Aspect 30: The method of any of Aspects 1-29, wherein receiving the indication of the one or more connections between the first set of resources and the second set of resources comprises: receiving a configuration for the CSI report, wherein the configuration comprises the indication of the one or more connections between the first set of resources and the second set of resources.

Aspect 31: The method of Aspect 30, wherein the configuration for the CSI report indicates that the first set of resources are channel measurement resources associated with the CSI report and that the second set of resources are references associated with a report quantity associated with the CSI report.

Aspect 32: The method of any of Aspects 1-31, wherein receiving the indication of the one or more connections between the first set of resources and the second set of resources comprises: receiving a CSI report setting associated with the CSI report, wherein the CSI report setting comprises the indication of the one or more connections between the first set of resources and the second set of resources.

Aspect 33: The method of any of Aspects 1-32, wherein receiving the indication of the one or more connections between the first set of resources and the second set of resources comprises: receiving a CSI resource setting associated with the CSI report, wherein the CSI resource setting comprises the indication of the one or more connections between the first set of resources and the second set of resources.

Aspect 34: The method of any of Aspects 1-33, wherein receiving the indication of the one or more connections between the first set of resources and the second set of resources comprises: receiving a medium access control (MAC) control element (MAC-CE) communication activating a transmission of the CSI report, wherein the MAC-CE communication comprises the indication of the one or more connections between the first set of resources and the second set of resources.

Aspect 35: The method of any of Aspects 1-34, wherein receiving the indication of the one or more connections between the first set of resources and the second set of resources comprises: receiving downlink control information triggering a triggering state associated with the CSI report, wherein the triggering state comprises the indication of the one or more connections between the first set of resources and the second set of resources.

Aspect 36: The method of any of Aspects 1-35, further comprising: receiving an indication of a transmission configuration indicator (TCI) state that is associated with a quasi co-location (QCL) source reference that is associated with at least one resource from the second set of resources.

Aspect 37: The method of Aspect 36, wherein the TCI state is a known TCI state based at least in part on a measurement value associated with the at least one resource being included in the second one or more measurement values included in the CSI report.

Aspect 38: The method of any of Aspects 1-37, wherein receiving the indication of the one or more connections between the first set of resources and the second set of resources comprises: receiving a radio resource control (RRC) configuration including information associated with respective resources from the first set of resources and the second set of resources, wherein the RRC configuration comprises the indication of the one or more connections between the first set of resources and the second set of resources.

Aspect 39: A method of wireless communication performed by a network node, comprising: transmitting, by the network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and receiving, by the network node, a channel state information (CSI) report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.

Aspect 40: The method of Aspect 39, wherein the connection indicates a relationship between a first spatial direction or a first beam associated with the resource and second spatial directions or second beams of the one or more resources included in the different set of resources.

Aspect 41: The method of any of Aspects 39-40, wherein the first set of resources are channel measurement resources for the CSI report, and wherein a report quantity associated with the CSI report is based at least in part on the second set of resources.

Aspect 42: The method of any of Aspects 39-41, wherein the first set of resources comprise one or more downlink reference signal resources.

Aspect 43: The method of any of Aspects 39-42, wherein the second set of resources comprise one or more downlink reference signal resources.

Aspect 44: The method of any of Aspects 39-43, wherein the second set of resources comprise one or more virtual resources.

Aspect 45: The method of any of Aspects 39-44, wherein a resource, included in the second set of resources, is a quasi co-location (QCL) source resource for a transmission configuration indicator (TCI) state.

Aspect 46: The method of Aspect 45, wherein the QCL source resource is a Type D QCL source resource.

Aspect 47: The method of any of Aspects 39-46, wherein the one or more connections comprise a graph-based connection.

Aspect 48: The method of Aspect 47, wherein a graph associated with the graph-based connection comprises nodes for respective resources included in the first set of resources and the second set of resources, and one or more edges, wherein a first edge, from the one or more edges, indicates a connection between a first node associated with the first set of resources and a second node associated with the second set of resources.

Aspect 49: The method of Aspect 48, wherein the second node is further associated with a second edge indicating a connection between the second node and a third node that is associated with the first set of resources.

Aspect 50: The method of any of Aspects 48-49, wherein each edge, of the one or more edges, indicates a probability level or a strength level of a spatial connection between two nodes associated with different sets of resources from the first set of resources and the second set of resources.

Aspect 51: The method of any of Aspects 47-50, wherein transmitting the indication of the one or more connections between the first set of resources and the second set of resources comprises: transmitting an indication of an adjacency matrix indicating a graph associated with the graph-based connection, wherein the one or more connections are indicated by respective elements of the adjacency matrix.

Aspect 52: The method of Aspect 51, wherein the respective elements of the adjacency matrix indicate probability levels or a strength levels associated with the one or more connections.

Aspect 53: The method of any of Aspects 47-52, wherein transmitting the indication of the one or more connections between the first set of resources and the second set of resources comprises: transmitting an indication of an adjacency list indicating a graph associated with the graph-based connection, wherein the one or more connections are indicated by respective neighboring nodes in the adjacency list.

Aspect 54: The method of Aspect 53, wherein the respective neighboring nodes indicate probability levels or a strength levels associated with the one or more connections.

Aspect 55: The method of any of Aspects 39-54, wherein the connection indicates a spatial superposition relationship between a first spatial direction or a first beam associated with the resource and second spatial directions or second beams associated with the one or more resources included in the different set of resources.

Aspect 56: The method of Aspect 55, wherein the connection indicates that a first beam width of the first beam associated with the resource is overlapping with second beam widths of the second beams.

Aspect 57: The method of Aspect 56, wherein a beam width, from the first beam width or the second beam widths, comprises an angular spread that is associated with an attenuation difference from a peak beamforming gain, of a beam associated with the beam width, that satisfies a threshold.

Aspect 58: The method of Aspect 57, wherein a value of the threshold is included in the indication of the one or more connections between the first set of resources and the second set of resources.

Aspect 59: The method of any of Aspects 57-58, wherein the threshold comprises a first threshold associated with the first set of resources and a second threshold associated with the second set of resources.

Aspect 60: The method of any of Aspects 39-46, wherein the one or more connections comprise linear combination based connections.

Aspect 61: The method of Aspect 60, wherein the resource is included in the second set of resources and the one or more resources are included in the first set of resources, and wherein the linear combination based connections indicate that the connection is associated with a linear combination of the one or more resources.

Aspect 62: The method of Aspect 61, wherein the linear combination is associated with linear combination coefficients associated with respective resources from the one or more resources.

Aspect 63: The method of Aspect 62, wherein the linear combination coefficients are amplitude and phase coefficients.

Aspect 64: The method of any of Aspects 60-63, wherein transmitting the indication of the one or more connections between the first set of resources and the second set of resources comprises: transmitting an indication of a matrix indicating the linear combination based connections, wherein linear combination coefficients are indicated by respective elements of the matrix.

Aspect 65: The method of any of Aspects 60-64, wherein transmitting the indication of the one or more connections between the first set of resources and the second set of resources comprises: transmitting an indication of a codebook matrix associated with the first set of resources and the second set of resources and a polarization matrix, wherein linear combination coefficients are indicated by respective elements of the codebook matrix.

Aspect 66: The method of any of Aspects 60-65, wherein transmitting the indication of the one or more connections between the first set of resources and the second set of resources comprises: transmitting an indication of an adjacency list indicating the linear combination based connections, wherein linear combination coefficients are indicated by respective neighboring nodes in the adjacency list.

Aspect 67: The method of any of Aspects 60-66, wherein the resource is included in the first set of resources and the one or more resources are included in the second set of resources, and wherein the linear combination based connections indicate that the connection is associated with a linear combination of the one or more resources.

Aspect 68: The method of any of Aspects 39-67, wherein transmitting the indication of the one or more connections between the first set of resources and the second set of resources comprises: transmitting a configuration for the CSI report, wherein the configuration comprises the indication of the one or more connections between the first set of resources and the second set of resources.

Aspect 69: The method of Aspect 68, wherein the configuration for the CSI report indicates that the first set of resources are channel measurement resources associated with the CSI report and that the second set of resources are references associated with a report quantity associated with the CSI report.

Aspect 70: The method of any of Aspects 39-69, wherein transmitting the indication of the one or more connections between the first set of resources and the second set of resources comprises: transmitting a CSI report setting associated with the CSI report, wherein the CSI report setting comprises the indication of the one or more connections between the first set of resources and the second set of resources.

Aspect 71: The method of any of Aspects 39-70, wherein transmitting the indication of the one or more connections between the first set of resources and the second set of resources comprises: transmitting a CSI resource setting associated with the CSI report, wherein the CSI resource setting comprises the indication of the one or more connections between the first set of resources and the second set of resources.

Aspect 72: The method of any of Aspects 39-71, wherein transmitting the indication of the one or more connections between the first set of resources and the second set of resources comprises: transmitting a medium access control (MAC) control element (MAC-CE) communication activating a transmission of the CSI report, wherein the MAC-CE communication comprises the indication of the one or more connections between the first set of resources and the second set of resources.

Aspect 73: The method of any of Aspects 39-72, wherein transmitting the indication of the one or more connections between the first set of resources and the second set of resources comprises: transmitting downlink control information triggering a triggering state associated with the CSI report, wherein the triggering state comprises the indication of the one or more connections between the first set of resources and the second set of resources.

Aspect 74: The method of any of Aspects 39-73, further comprising: transmitting an indication of a transmission configuration indicator (TCI) state that is associated with a quasi co-location (QCL) source reference that is associated with at least one resource from the second set of resources.

Aspect 75: The method of Aspect 74, wherein the TCI state is a known TCI state based at least in part on a measurement value associated with the at least one resource being included in the second one or more measurement values included in the CSI report.

Aspect 76: The method of any of Aspects 39-75, wherein transmitting the indication of the one or more connections between the first set of resources and the second set of resources comprises: transmitting a radio resource control (RRC) configuration including information associated with respective resources from the first set of resources and the second set of resources, wherein the RRC configuration comprises the indication of the one or more connections between the first set of resources and the second set of resources.

Aspect 77: An apparatus for wireless communication at a device, comprising a processor; memory coupled with the processor; and instructions stored in the memory and executable by the processor to cause the apparatus to perform the method of one or more of Aspects 1-38.

Aspect 78: A device for wireless communication, comprising a memory and one or more processors coupled to the memory, the one or more processors configured to perform the method of one or more of Aspects 1-38.

Aspect 79: An apparatus for wireless communication, comprising at least one means for performing the method of one or more of Aspects 1-38.

Aspect 80: A non-transitory computer-readable medium storing code for wireless communication, the code comprising instructions executable by a processor to perform the method of one or more of Aspects 1-38.

Aspect 81: A non-transitory computer-readable medium storing a set of instructions for wireless communication, the set of instructions comprising one or more instructions that, when executed by one or more processors of a device, cause the device to perform the method of one or more of Aspects 1-38.

Aspect 82: An apparatus for wireless communication at a device, comprising a processor; memory coupled with the processor; and instructions stored in the memory and executable by the processor to cause the apparatus to perform the method of one or more of Aspects 39-76.

Aspect 83: A device for wireless communication, comprising a memory and one or more processors coupled to the memory, the one or more processors configured to perform the method of one or more of Aspects 39-76.

Aspect 84: An apparatus for wireless communication, comprising at least one means for performing the method of one or more of Aspects 39-76.

Aspect 85: A non-transitory computer-readable medium storing code for wireless communication, the code comprising instructions executable by a processor to perform the method of one or more of Aspects 39-76.

Aspect 86: A non-transitory computer-readable medium storing a set of instructions for wireless communication, the set of instructions comprising one or more instructions that, when executed by one or more processors of a device, cause the device to perform the method of one or more of Aspects 39-76.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A mobile station for wireless communication, comprising:
a memory; and
one or more processors, coupled to the memory and based at least in part on information stored in the memory, configured to:
receive, from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and
transmit, to the network node, a channel state information (CSI) report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections.

2. The mobile station of claim 1, wherein the first set of resources are channel measurement resources for the CSI report, and wherein a report quantity associated with the CSI report is based at least in part on the second set of resources.

3. The mobile station of claim 1, wherein a resource, included in the second set of resources, is a quasi co-location (QCL) source resource for a transmission configuration indicator (TCI) state.

4. The mobile station of claim 1, wherein the one or more connections comprise a graph-based connection.

5. The mobile station of claim 4, wherein a graph associated with the graph-based connection comprises nodes for respective resources included in the first set of resources and the second set of resources, and one or more edges, wherein a first edge, from the one or more edges, indicates a connection between a first node associated with the first set of resources and a second node associated with the second set of resources.

6. The mobile station of claim 4, wherein the one or more processors, to receive the indication of the one or more connections between the first set of resources and the second set of resources, are configured to:
receive an indication of an adjacency matrix indicating a graph associated with the graph-based connection, wherein the one or more connections are indicated by respective elements of the adjacency matrix.

7. The mobile station of claim 4, wherein the one or more processors, to receive the indication of the one or more connections between the first set of resources and the second set of resources, are configured to:
receive an indication of an adjacency list indicating a graph associated with the graph-based connection, wherein the one or more connections are indicated by respective neighboring nodes in the adjacency list.

8. The mobile station of claim 1, wherein the connection indicates a spatial superposition relationship between a first spatial direction or a first beam associated with the resource and second spatial directions or second beams associated with the one or more resources included in the different set of resources, wherein the connection indicates that a first beam width of the first beam associated with the resource is overlapping with second beam widths of the second beams.

9. The mobile station of claim 8, wherein a beam width, from the first beam width or the second beam widths, comprises an angular spread that is associated with an attenuation difference from a peak beamforming gain, of a beam associated with the beam width, that satisfies a threshold.

10. The mobile station of claim 1, wherein the one or more connections comprise linear combination based connections, wherein the resource is included in the second set of resources and the one or more resources are included in the first set of resources, and wherein the linear combination based connections indicate that the connection is associated with a linear combination of the one or more resources.

11. The mobile station of claim 10, wherein the one or more processors, to receive the indication of the one or more connections between the first set of resources and the second set of resources, are configured to:
receive an indication of a matrix indicating the linear combination based connections, wherein linear combination coefficients are indicated by respective elements of the matrix.

12. The mobile station of claim 10, wherein the one or more processors, to receive the indication of the one or more connections between the first set of resources and the second set of resources, are configured to:
receive an indication of a codebook matrix associated with the first set of resources and the second set of resources and a polarization matrix, wherein linear combination coefficients are indicated by respective elements of the codebook matrix.

13. The mobile station of claim 10, wherein the one or more processors, to receive the indication of the one or more connections between the first set of resources and the second set of resources, are configured to:
receive an indication of an adjacency list indicating the linear combination based connections, wherein linear combination coefficients are indicated by respective neighboring nodes in the adjacency list.

14. A network node for wireless communication, comprising:
a memory; and
one or more processors, coupled to the memory and based at least in part on information stored in the memory, configured to:
transmit an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and
receive a channel state information (CSI) report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.

15. The network node of claim 14, wherein the connection indicates a relationship between a first spatial direction or a first beam associated with the resource and second spatial directions or second beams of the one or more resources included in the different set of resources.

16. A method of wireless communication performed by a mobile station, comprising:
receiving, by the mobile station and from a network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and
transmitting, by the mobile station and to the network node, a channel state information (CSI) report indicating measurement values associated with the first set of resources and the second set of resources, wherein a first one or more measurement values, from the measurement values, associated with the first set of resources are measured by the mobile station, and wherein a second one or more measurement values, from the measurement values, associated with the second set of resources are predicted by the mobile station based at least in part on the first one or more measurement values and the one or more connections.

17. The method of claim 16, wherein the first set of resources are channel measurement resources for the CSI report, and wherein a report quantity associated with the CSI report is based at least in part on the second set of resources.

18. The method of claim 16, wherein a resource, included in the second set of resources, is a quasi co-location (QCL) source resource for a transmission configuration indicator (TCI) state.

19. The method of claim 16, wherein the one or more connections comprise a graph-based connection.

20. The method of claim 16, wherein the connection indicates a spatial superposition relationship between a first spatial direction or a first beam associated with the resource and second spatial directions or second beams associated with the one or more resources included in the different set of resources, wherein the connection indicates that a first beam width of the first beam associated with the resource is overlapping with second beam widths of the second beams.

21. The method of claim 16, wherein the one or more connections comprise linear combination based connections.

22. The method of claim 16, wherein receiving the indication of the one or more connections between the first set of resources and the second set of resources comprises:
receiving a configuration for the CSI report, wherein the configuration comprises the indication of the one or more connections between the first set of resources and the second set of resources.

23. The method of claim 16, wherein receiving the indication of the one or more connections between the first set of resources and the second set of resources comprises:
receiving a CSI report setting associated with the CSI report, wherein the CSI report setting comprises the indication of the one or more connections between the first set of resources and the second set of resources.

24. The method of claim 16, wherein receiving the indication of the one or more connections between the first set of resources and the second set of resources comprises:
receiving a CSI resource setting associated with the CSI report, wherein the CSI resource setting comprises the indication of the one or more connections between the first set of resources and the second set of resources.

25. The method of claim 16, wherein receiving the indication of the one or more connections between the first set of resources and the second set of resources comprises:
receiving a medium access control (MAC) control element (MAC-CE) communication activating a transmission of the CSI report, wherein the MAC-CE communication comprises the indication of the one or more connections between the first set of resources and the second set of resources.

26. The method of claim 16, wherein receiving the indication of the one or more connections between the first set of resources and the second set of resources comprises:
receiving downlink control information triggering a triggering state associated with the CSI report, wherein the triggering state comprises the indication of the one or more connections between the first set of resources and the second set of resources.

27. The method of claim 16, further comprising:
receiving an indication of a transmission configuration indicator (TCI) state that is associated with a quasi co-location (QCL) source reference that is associated with at least one resource from the second set of resources.

28. The method of claim 27, wherein the TCI state is a known TCI state based at least in part on a measurement value associated with the at least one resource being included in the second one or more measurement values included in the CSI report.

29. The method of claim 16, wherein receiving the indication of the one or more connections between the first set of resources and the second set of resources comprises:
receiving a radio resource control (RRC) configuration including information associated with respective resources from the first set of resources and the second set of resources, wherein the RRC configuration comprises the indication of the one or more connections between the first set of resources and the second set of resources.

30. A method of wireless communication performed by a network node, comprising:
transmitting, by the network node, an indication of a first set of resources and a second set of resources and an indication of one or more connections between the first set of resources and the second set of resources, wherein the one or more connections comprise a connection associated with a resource included in the first set of resources or the second set of resources, and wherein the connection is defined with respect to one or more resources included in a different set of resources from the first set of resources or the second set of resources; and
receiving, by the network node, a channel state information (CSI) report associated with a mobile station indicating measurement values associated with the first set of resources and the second set of resources, wherein a first one or more measurement values, from the measurement values, associated with the first set of resources are measured, and wherein a second one or more measurement values, from the measurement values, associated with the second set of resources are predicted based at least in part on the first one or more measurement values and the one or more connections.
